(19) United States
(12) Patent Application Publication
(10) Pub. No.: US 2025/0079872 A1
(43) Pub. Date: Mar. 6, 2025

(54) CHARGER INTEGRATED CIRCUITS AND ELECTRONIC DEVICES INCLUDING THE SAME

(71) Applicant: SAMSUNG ELECTRONICS CO., LTD., Suwon-si (KR)

(72) Inventors: Sang Hee KANG, Suwon-si (KR); Pradipta PATRA, Bangalore (KR)

(21) Appl. No.: 18/662,282

(22) Filed: May 13, 2024

(30) Foreign Application Priority Data
Aug. 29, 2023 (KR) 10-2023-0113303

(51) Int. Cl. H02J 7/00; H02M 1/00; H02M 3/158

(52) U.S. Cl. CPC H02J 7/00714; H02J 7/00711; H02M 1/0009; H02M 1/0025; H02M 3/158; H02J 2207/20

(57) ABSTRACT

An electronic device comprising: a charger integrated circuit configured to perform a buck converting operation based on an input voltage applied to a first node thereof to generate an output voltage output to a second node thereof, wherein the charger integrated circuit includes: a power switching circuit including a flying capacitor; a current sensing circuit that includes an inductor; and a control circuit that includes: a compensation circuit that is configured to compensate an inductor current value that is sensed from the current sensing circuit; an error voltage select circuit that is configured to generate a minimum error voltage based on feedback signals; and a comparison circuit that is configured to control a voltage of the flying capacitor, wherein the control circuit is configured to generate a control voltage by modifying the inductor current value based on the minimum error voltage and provide the control voltage to the comparison circuit.

### CROSS-REFERENCE TO RELATED APPLICATION

This application claims priority from Korean Patent Application No. 10-2023-0113303 filed on Aug. 29, 2023 in the Korean Intellectual Property Office, and all the benefits accruing therefrom under 35 U.S.C. 119, the contents of which in its entirety are herein incorporated by reference.

### BACKGROUND

The present disclosure relates to a charger integrated circuit and an electronic device including the same.

With the rapid development of electronic devices, a variety of electronic devices capable of exchanging information or data with each other are being used. The electronic devices may employ a rechargeable battery as a power supply to provide advantage of mobility. The rechargeable battery's capacity is limited, and thus a user may need to properly charge the rechargeable battery before it is exhausted out.

DC-DC converters, for example, switching converters such as buck converters, may convert an input voltage to an output voltage using a switching transistor. The buck converters may use an inductor and/or a capacitor to generate and regulate an output voltage to a load (e.g., the rechargeable battery).

In charging circuits using a conventional 3-level buck converter, a voltage mode control scheme in which an output voltage is used as a feedback to control a voltage charged to the battery (e.g., the rechargeable battery) and a current flowing through the battery may be applied. In this regard, in the voltage mode control scheme, it may be difficult to implement satisfactory control characteristics, compared to a current mode control scheme in which an inductor current of the circuit is detected for use (e.g., for feedback).

### SUMMARY

One technical purpose that the present disclosure seeks to achieve is to provide a charger integrated circuit that may secure stable control characteristics using a detected inductor current.

Another technical purpose that the present disclosure aims to solve is to provide an electronic device that may secure stable control characteristics using a detected inductor current.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

An electronic device according to some embodiments of the present a battery; and a charger integrated circuit that is configured to perform a buck converting operation based on an input voltage that is applied to a first node thereof to generate an output voltage output to a second node thereof, wherein the charger integrated circuit includes: a power switching circuit that is configured to receive the input voltage, wherein the power switching circuit includes first, second, third, and fourth switching transistors and a flying capacitor that is electrically connected to a first end of the second switching transistor and a first end of the third switching transistor; a current sensing circuit that includes an inductor that is electrically connected to and disposed between the second node and a third node, wherein the third node is electrically connected to a second end of the second switching transistor and a second end of the third switching transistor; and a control circuit that includes: a compensation circuit that is configured to compensate an inductor current value that is sensed from the current sensing circuit; an error voltage select circuit that is configured to generate a minimum error voltage based on feedback signals; and a comparison circuit that is configured to control a voltage of the flying capacitor, wherein the control circuit is configured to generate a control voltage by modifying the inductor current value based on the minimum error voltage and provide the control voltage to a first input stage of the comparison circuit.

A charger integrated circuit according to some embodiments of the present disclosure includes a converting circuit that is configured to generate an output voltage that outputs to a second node thereof based on an input voltage that is applied to a first node thereof; and a control circuit that is configured to generate a first pulse width modulation (PWM) signal and a second PWM signal for controlling the converting circuit, wherein the converting circuit includes: a power switching circuit that is configured to receive the input voltage, wherein the power switching circuit includes first, second, third, and fourth switching transistors that are electrically connected in series with each other and a flying capacitor that is electrically connected to a first end of the second switching transistor and a first end of the third switching transistor; and a current sensing circuit that includes an inductor that is electrically connected to a third node and disposed between the third node and the second node, wherein the control circuit includes: a compensation circuit that is configured to compensate an inductor current value that is sensed from the current sensing circuit; an error voltage select circuit that is configured to generate a minimum error voltage based on feedback signals; and a comparison circuit that is configured to control a voltage of the flying capacitor, wherein the inductor current value is compensated to have a same value as the minimum error voltage.

A charger integrated circuit according to some embodiments of the present disclosure includes a converting circuit that is configured to generate an output voltage that outputs to a second node thereof based on an input voltage that is applied to a first node thereof; and a control circuit that is configured to generate first, second, third, and fourth switching voltages based on a signal that is provided from the converting circuit, wherein the converting circuit includes: an input/output select circuit that includes a first input transistor that is configured to receive a first input voltage and a second input transistor that is configured to receive a second input voltage; a power switching circuit that is configured to receive the input voltage based on the first input voltage and/or the second input voltage and includes first, second, third, and fourth switching transistors that are electrically connected in series with each other and a flying capacitor that is electrically connected to a first end of the second switching transistor and a first end of the third switching transistor, and a current sensing circuit that includes an inductor that is electrically connected to a third node and disposed between the third node and the second node, wherein a control voltage is generated based on an inductor current value sensed from the inductor of the current sensing circuit, wherein the control voltage is provided to an input stage of the control circuit, wherein the control circuit is configured to: control a magnitude of each of the control voltage and first and second comparison voltages; and control a duration for which each of the first, second, third, and fourth switching transistors is turned on so that a voltage of the flying capacitor is balanced to have half voltage of the input voltage.

Details of other embodiments are included in the detailed description and drawings.

### BRIEF DESCRIPTION OF DRAWINGS

The above and other aspects and features of the present disclosure will become more apparent by describing in detail illustrative embodiments thereof with reference to the attached drawings, in which:

FIG. 1 is a block diagram schematically showing an electronic device including a charger integrated circuit according to some embodiments;

FIG. 2 is a diagram for illustrating a converting circuit of a charger integrated circuit according to some embodiments;

FIG. 3 and FIG. 4 are timing diagrams when a charger integrated circuit according to some embodiments performs a buck converting operation;

FIG. 5 is a diagram for illustrating a control circuit of a charger integrated circuit according to some embodiments;

FIG. 6 is a diagram for illustrating a control logic and a gate driver of a charger integrated circuit according to some embodiments;

FIG. 7 and FIG. 8 are timing diagrams of signals of a converting circuit and a control circuit according to some embodiments;

FIGS. 9 to 12 are diagrams for illustrating effects of using a charger integrated circuit according to some embodiments; and

FIG. 13 is a diagram schematically showing an electronic device including a charger integrated circuit according to some embodiments.

### DETAILED DESCRIPTIONS

In the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included in the scope of the present disclosure as defined by the appended claims.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof.

It will be understood that, although the terms “first”, “second”, “third”, and so on may be used herein to illustrate various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the scope of the present disclosure.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In one example, when a certain embodiment may be implemented differently, a function or operation specified in a specific block may occur in a sequence different from that specified in a flowchart. For example, two consecutive blocks may be actually executed at the same time. Depending on a related function or operation, the blocks may be executed in a reverse sequence.

In descriptions of temporal relationships, for example, temporal precedent relationships between two events such as “after”, “subsequent to”, “before”, etc., another event may occur therebetween unless “directly after”, “directly subsequent” or “directly before” is not indicated.

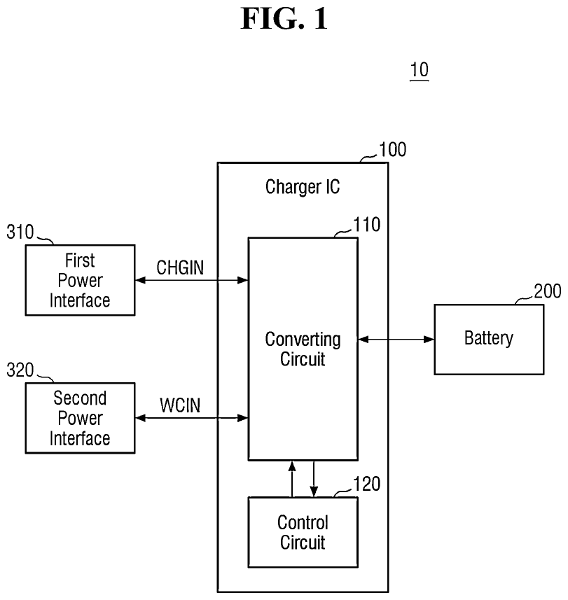

Hereinafter, with reference to FIGS. 1 to 8, charger integrated circuits and electronic devices including the same according to some embodiments will be described.

FIG. 1 is a block diagram schematically showing an electronic device including a charger integrated circuit according to some embodiments.

Referring to FIG. 1, an electronic device 10 may include a charger integrated circuit 100 and a battery 200. The electronic device 10 may further include a main processor and peripheral devices. For example, the electronic device 10 may be a mobile device such as a smart phone, a tablet PC (Personal Computer), a mobile phone, PDA (Personal Digital Assistant), a laptop, a wearable device, a GPS (Global Positional System) device, an e-book terminal, a digital broadcasting terminal, a MP3 player, a digital camera, etc. For example, the electronic device 10 may be an electric vehicle.

The battery 200 may be built into the electronic device 10. In some embodiments, the battery 200 may be removable from the electronic device 10. The battery 200 may include one or plurality of battery cells. The plurality of battery cells may be connected (e.g., electrically connected) to each other in a series or parallel manner. When an external charging device is not connected (e.g., not electrically connected) to the electronic device 10, the battery 200 may supply power to the electronic device 10. It will be understood that when an element or layer is referred to as being “connected to”, or “coupled to” another element or layer, it may be directly on, connected to, or coupled to the other element or layer, or one or more intervening elements or layers may be present. In contrast, when an element is referred to as being “directly coupled,” “directly connected,” or “directly responsive” to, or “directly on,” another element, there are no intervening elements present. In addition, “electrical connection” conceptually includes a physical connection and a physical disconnection. In addition, it will also be understood that when an element or layer is referred to as being “between” two elements or layers, it may be the only element or layer between the two elements or layers, or one or more intervening elements or layers may also be present. As used hereinafter, the terms “external/outside configuration”, “external/outside device”, “external/outside power”, “external/outside signal”, or “outside” are intended to broadly refer to a device, circuit, block, module, power, and/or signal that resides externally (e.g., outside of a functional or physical boundary) with respect to a given circuit, block, module, system, or device.

The charger integrated circuit 100 may charge the battery 200 and may be referred to as a “battery charger.” Furthermore, the charger integrated circuit 100 may supply power to an external device (e.g., a first power interface 310 and/or a second power interface 320) connected (e.g., electrically connected) to the charger integrated circuit 100, based on a voltage charged into the battery 200. The first power interface 310 may be a wired power interface to be described later, and the second power interface 320 may be a wireless power interface to be described later. For example, the charger integrated circuit 100 may be implemented as one or more integrated circuit chips and may be mounted on a printed circuit board.

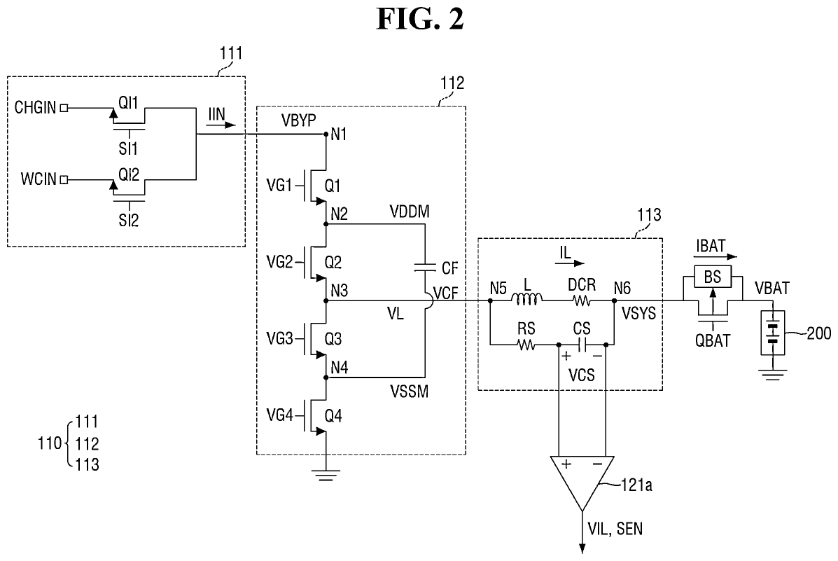

The charger integrated circuit 100 may include a converting circuit 110 and a control circuit 120. The converting circuit 110 may be implemented as a 3-level DC-DC converter including a plurality of switching transistors (e.g., Q1, Q2, Q3, and Q4 in FIG. 2), a flying capacitor (e.g., CF in FIG. 2), and an inductor (e.g., L in FIG. 2). In this regard, a 3-level refers to the number of voltage levels used in a switching operation. The 3-level DC-DC converter may switch an input voltage, a (1/2)*input voltage (a half voltage of the input voltage), and a ground voltage (e.g., 0V) to generate an output voltage. For example, the converting circuit 110 may perform a buck converting operation to step down the input voltage to generate the output voltage.

When the converting circuit 110 steps down the input voltage, that is, during the buck converting operation, a power path through which power is provided from at least one external device connected (e.g., electrically connected) to the battery via the wired power interface 310 and/or the wireless power interface 320 to the battery 200 may be formed.

The converting circuit 110 may step down the input voltage by performing the buck converting operation, may charge the battery 200 based on the stepped-down voltage.

The control circuit 120 may control the switching operation of the converting circuit 110.

The control circuit 120 may control the switching operation of the converting circuit 110 such that a voltage (hereinafter, referred to as a flying capacitor voltage) across both opposing ends of the flying capacitor (e.g., CF in FIG. 2) disposed in the converting circuit 110 may be maintained at a target level, for example, a set target level of the flying capacitor voltage.

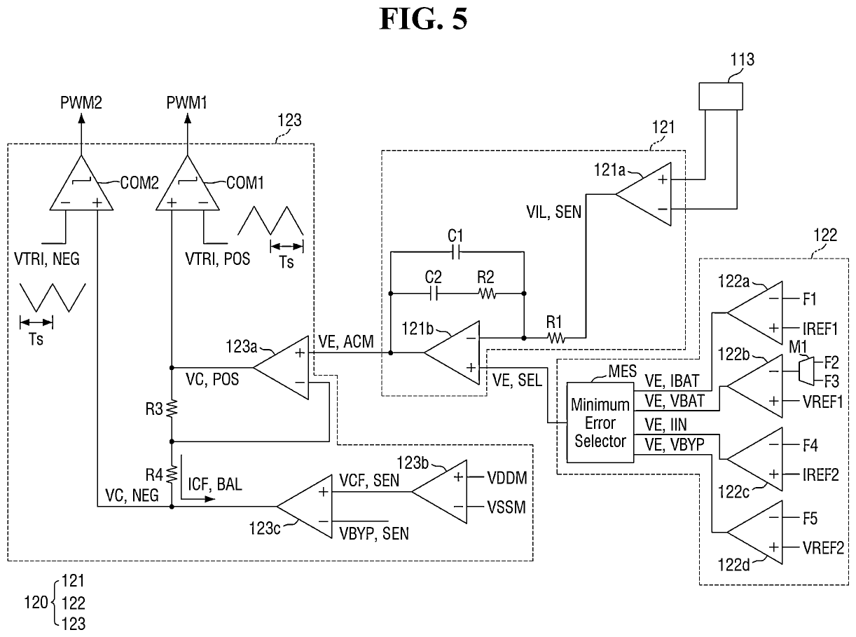

The control circuit 120 may generate signals (e.g., PWM1 and PWM2 in FIG. 5) to control the switching operation of the converting circuit 110. For example, the control circuit 120 may generate a first PWM (Pulse Width Modulation) signal (e.g., PWM1 in FIG. 5) and a second PWM signal (e.g., PWM2 in FIG. 5) based on the currents (e.g., IL, IBAT, and IIN in FIG. 2 and FIG. 5) and may provide the signals (e.g., PWM1 and PWM2 in FIG. 5) to the converting circuit 110. Regarding the signals (e.g., PWM1 and PWM2 in FIG. 5), at least two switching transistors among a plurality of switching transistors (e.g., Q1, Q2, Q3, and Q4 in FIG. 2) disposed in the converting circuit 110 may be turned on or off based on the first PWM signal (e.g., PWM1 in FIG. 5), while at least two other switching transistors thereof may be turned on or off based on the second PWM signal (e.g., PWM2 in FIG. 5).

The control circuit 120 may sense an inductor current IL flowing in an inductor L disposed in the converting circuit 110, and may convert the sensed inductor current IL into information about an average value thereof, and may adjust an on period or an off period of each of the plurality of switching transistors (e.g., Q1, Q2, Q3, and Q4 in FIG. 2) based on the information such that the flying capacitor voltage VCF may be controlled to be maintained at the target voltage. This may be referred to as flying capacitor balancing. In this way, stable control characteristics of the charger integrated circuit 100 may be secured while the flying capacitor balancing is maintained.

Converting the sensed inductor current (e.g., the inductor current IL) into the information about the average value thereof and flying capacitor balancing is performed based on the information will be described later with reference to FIGS. 2 to 8.

In some embodiments, the electronic device 10 may support wired charging and/or wireless charging, and may include the wired power interface 310 and/or the wireless power interface 320 for wired charging and/or wireless charging. The wired power interface 310 may include a wired charging circuit. The wireless power interface 320 may include a wireless charging circuit. For example, each of the wired charging circuit and the wireless charging circuit may include a rectifier, a regulator, etc.

The charger integrated circuit 100 may receive a first input voltage CHGIN from the wired power interface 310 and/or a second input voltage WCIN from the wireless power interface 320, and may charge the battery 200 based on the first input voltage CHGIN and/or the second input voltage WCIN.

For example, a TA (travel adapter) or an auxiliary battery may be electrically connected to the wired power interface 310. The TA may convert AC 110V to AC 220V as a household power, or power supplied from another power supply means (e.g., a computer) into DC power required for charging the battery 200 and provide the DC power to the electronic device 10. The charger integrated circuit 100 may charge the battery 200 using the first input voltage CHGIN received from the TA or the auxiliary battery.

For example, a wireless power reception circuit or a wireless power transmission circuit may be connected (e.g., electrically connected) to the wireless power interface 320. The charger integrated circuit 100 may charge the battery 200 using the second input voltage WCIN received from the wireless power reception circuit.

In this way, the charger integrated circuit 100 may operate to support the wired charging and/or wireless charging.

FIG. 2 is a diagram for illustrating the converting circuit of the charger integrated circuit according to some embodiments.

Referring to FIG. 2, the converting circuit 110 may include an input/output select circuit 111, a power switching circuit 112, and a current sensing circuit 113.

The input/output select circuit 111 may include a first input transistor QI1 and a second input transistor Q12. The first input transistor QI1 and the second input transistor Q12 may be connected (e.g., electrically connected) in parallel with each other.

The first input voltage CHGIN may be applied to the first input transistor QI1 or an OTG device may be connected (e.g., electrically connected) thereto. The second input voltage WCIN may be applied to the second input transistor Q12 or a wireless power transmission circuit may be connected (e.g., electrically connected) thereto.

The first input transistor QI1 may be turned on or off in response to a first input control signal SI1, while the second input transistor Q12 may be turned on or off in response to a second input control signal SI2. For example, when the first input voltage CHGIN is applied to the first input transistor QI1 or the OTG device is connected thereto, the first input control signal SI1 may have an active level, and the first input transistor QI1 may be turned on in response to the first input control signal SI1. When the second input voltage WCIN is applied to the second input transistor Q12, or the wireless transmission circuit is connected thereto, the second input control signal SI2 may have an active level, and the second input transistor Q12 may be turned on in response to the second input control signal SI2. The first input control signal SI1 and the second input control signal SI2 may be received from the control circuit (e.g., 120 in FIG. 1).

The power switching circuit 112 may include a plurality of switching transistors including the first switching transistor Q1, the second switching transistor Q2, the third switching transistor Q3, and the fourth switching transistor Q4 connected (e.g., electrically connected) in series with each other, and the flying capacitor CF.

The first switching transistor Q1, the second switching transistor Q2, the third switching transistor Q3, and the fourth switching transistor Q4 may be connected (e.g., electrically connected) in series to a first node N1. For example, one end of the first switching transistor Q1 may be connected (e.g., electrically connected) to the first node N1 while the other end thereof may be connected (e.g., electrically connected) to a second node N2. In some embodiments, one end of the second switching transistor Q2 may be connected (e.g., electrically connected) to the second node N2, while the other end thereof may be connected (e.g., electrically connected) to a third node N3. In some embodiments, one end of the third switching transistor Q3 may be connected (e.g., electrically connected) to the third node N3, while the other end thereof may be connected (e.g., electrically connected) to a fourth node N4. In some embodiments, one end of the fourth switching transistor Q4 may be connected (e.g., electrically connected) to the fourth node N4, while a ground voltage may be applied to the other end thereof.

The first switching transistor Q1 may be turned on or off in response to a first switching voltage VG1. The second switching transistor Q2 may be turned on or off in response to a second switching voltage VG2. The third switching transistor Q3 may be turned on or off in response to a third switching voltage VG3. The fourth switching transistor Q4 may be turned on or off in response to a fourth switching voltage VG4.

Each of the first, second, third, and fourth switching voltages VG1, VG2, VG3, and VG4 may be a periodic signal with a specific frequency.

In some embodiments, the first switching voltage VG1 and the fourth switching voltage VG4 may be complementary to each other, while the second switching voltage VG2 and the third switching voltage VG3 may be complementary to each other. Therefore, the first switching transistor Q1 and the fourth switching transistor Q4 may perform the switching operation in a complementary manner. The second switching transistor Q2 and the third switching transistor Q3 may perform the switching operation in a complementary manner.

In some embodiments, the flying capacitor CF may be connected (e.g., electrically connected) to the second node N2 and the fourth node N4. In other words, one end of the flying capacitor CF may be connected (e.g., electrically connected) to the other end of the first switching transistor Q1 and the one end of the second switching transistor Q2, while the other end of the flying capacitor CF may be connected (e.g., electrically connected) to the other end of the third switching transistor Q3 and the one end of the fourth switching transistor Q4. The voltage VCF of the flying capacitor CF may be equal to a difference between a voltage VDDM of the second node N2 and a voltage VSSM of the fourth node N4.

The current sensing circuit 113 may include an inductor L and a first resistor DCR connected (e.g., electrically connected), for example, in series with each other, and a second resistor RS and a sensing capacitor CS connected (e.g., electrically connected), for example, in series with each other. In some embodiments, the inductor L and the first resistor DCR may be connected (e.g., electrically connected), for example, in parallel with the second resistor RS and sensing capacitor (CS) based on a fifth node N5.

The inductor L may be connected (e.g., electrically connected) to and disposed between the third node N3 and a sixth node N6. The inductor L may store therein energy generated from the inductor current IL flowing through the inductor L, and may discharge the stored energy. According to the buck converting operation of the converting circuit 110, the inductor current IL may flow from the third node N3 to the sixth node N6.

The inductor current IL may be sensed through a voltage VCS across both opposing ends of the sensing capacitor CS, and may be amplified by an amplifier 121a, and may be converted to a voltage. A sensed inductor current value VIL, SEN as the converted value may be provided to the control circuit (e.g., 120 in FIG. 1).

The current IIN flowing in the first node N1, the input voltage VBYP, and an output voltage VSYS (also referred to as a system voltage VSYS), the fully-charged voltage VBAT of the battery 200, and the current IBAT flowing into the battery 200 may be provided to the control circuit (e.g., 120 in FIG. 1). The control circuit 120 may generate the first to fourth switching voltages VG1 to VG4 based on the signals provided from the converting circuit 110 and/or the signals from the battery 200.

The converting circuit 110 may operate as a buck converter to step down the input voltage VBYP to generate the output voltage. In this regard, the input voltage VBYP may be generated based on the first input voltage CHGIN or the second input voltage WCIN. The output voltage may be output as a system voltage VSYS via the sixth node N6. In this regard, the output voltage may have, for example, a voltage of 0 to about 4.4V. One end of the converting circuit 110 may be connected (e.g., electrically connected) to one end of a power supply transistor QBAT. The battery 200 may be charged based on the output voltage (e.g., the output voltage VSYS). The charged battery voltage VBAT of the battery 200 may be equal to the output voltage (e.g., the output voltage VSYS). A control switch BS for controlling the charging may be connected (e.g., electrically connected) to one end of the battery 200.

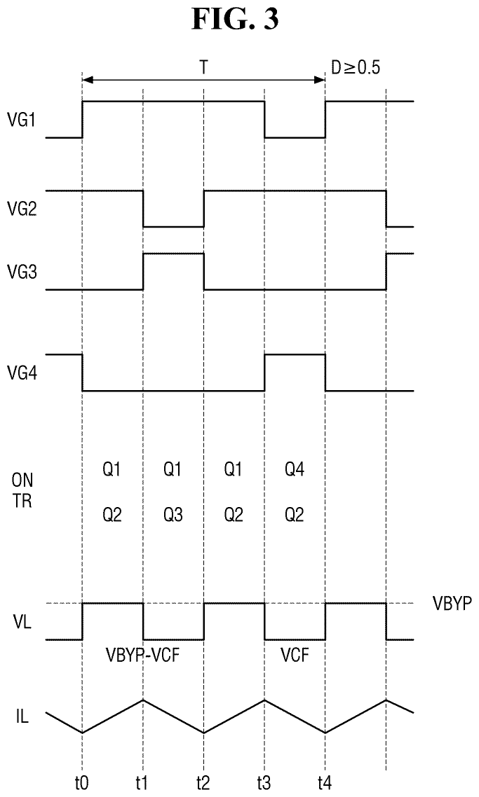

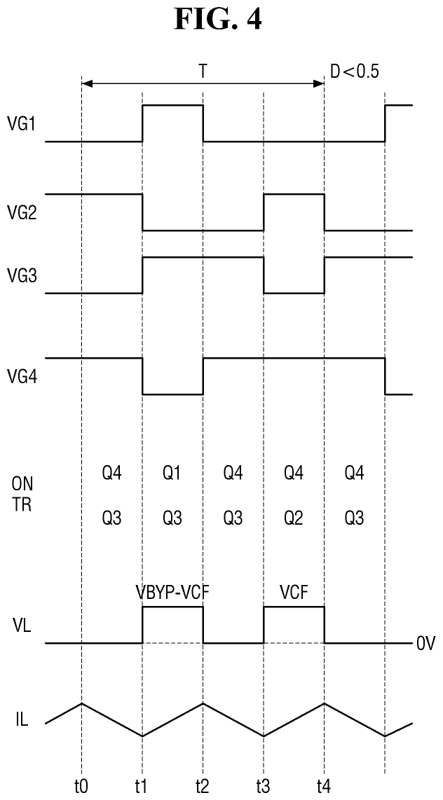

FIG. 3 and FIG. 4 are timing diagrams when the charger integrated circuit according to some embodiments performs the buck converting operation. For reference, FIG. 3 is a waveform diagram when a duty ratio is greater than or equal to 0.5, and FIG. 4 is a waveform diagram when the duty ratio smaller than 0.5.

The converting circuit 110 may perform a buck converting operation based on the first to fourth switching voltages VG1 to VG4. For example, when the first switching voltage VG1 is at an active level (e.g., logic high), the first switching transistor Q1 may be turned on. When the first switching voltage VG1 at an inactive level (e.g., logic low), the first switching transistor Q1 may be turned off.

A duration for which each of the first to fourth switching voltages VG1 to VG4 has each of the active level and the inactive level within one period may be variable.

In some embodiments, when the first switching transistor Q1 is turned on, the fourth switching transistor Q4 may be turned off. When the first switching transistor Q1 is turned off, the fourth switching transistor Q4 may be turned on. When the second switching transistor Q2 is turned on, the third switching transistor Q3 may be turned off. When the second switching transistor Q2 is turned off, the third switching transistor Q3 may be turned on.

Referring to FIG. 3, at a t0 time-point, when the first switching transistor Q1 and the second switching transistor Q2 are turned on, the input voltage, for example, the input voltage VBYP of the first node N1 may be applied to the third node N3, and a voltage VL of the third node N3 may have the same voltage level as that of the input voltage VBYP, and the inductor current IL may increase.

At a t1 time-point, when the second switching transistor Q2 is turned off, and the third switching transistor Q3 is turned on, current may flow to the inductor L via the first switching transistor Q1, the flying capacitor CF, and the third switching transistor Q3. The voltage VL of the third node N3 may have a voltage level obtained by subtracting the voltage VCF across both opposing ends of the flying capacitor CF from the input voltage VBYP of the first node N1. For example, when the voltage VCF across both opposing ends of the flying capacitor CF is ½ times (half voltage) of the input voltage VBYP of the first node N1 (e.g., 1/2*VBYP), the voltage VL of the third node N3 may have the same level (for example, 1/2*VBYP) as that of the voltage VCF across both opposing ends of the flying capacitor CF. Due to decrease in a level of voltage VL of the third node N3, the inductor current IL may decrease.

At a t2 time-point, when the third switching transistor Q3 is turned off, and the second switching transistor Q2 is turned on, the voltage VL of the third node N3 may have the same level as that of the input voltage VBYP of the first node N1, and the inductor current IL may increase.

At a t3 time-point, when the fourth switching transistor Q4 is turned on, and the first switching transistor Q1 is turned off, current may flow to the inductor L via the second switching transistor Q2, the flying capacitor VCF, and the fourth switching transistor Q4. The voltage VL of the third node N3 may have the same level (e.g., 1/2*VBYP (half voltage of the input voltage VBYP)) as that of the voltage VCF across both opposing ends of the flying capacitor CF. Due to the decrease in the level of the voltage VL of the third node N3, the inductor current IL may decrease.

Referring to FIG. 4, at the time-point t0, when the fourth switching transistor Q4 and the third switching transistor Q3 are turned on, a ground voltage (e.g., 0V) is applied to the third node N3, and the voltage VL of the third node N3 may have the same level as that of the ground voltage. The inductor current IL generated by the energy having been charged in the inductor L may be output, and the inductor current IL may decrease.

At the t1 time-point, when the fourth switching transistor Q4 is turned off, and the first switching transistor Q1 is turned on, current may flow to the inductor L via the first switching transistor Q1, the flying capacitor CF, and the third switching transistor Q3. The voltage VL of the third node N3 may have a level obtained by subtracting the voltage VCF across both opposing ends of the flying capacitor CF from the input voltage VBYP of the first node N1. For example, when the voltage VCF across both opposing ends of the flying capacitor CF is 1/2 times (half voltage) of the input voltage VBYP of the first node N1 (e.g., 1/2*VBYP), the voltage VL of the third node N3 may have a level (e.g., 1/2*VBYP) that is ½ times (half voltage) of the input voltage VBYP of the first node N1. Due to increase in the level of the voltage VL of the third node N3, the inductor current IL may increase.

At the t2 time-point, when the fourth switching transistor Q4 is turned on, and the first switching transistor Q1 is turned off, the voltage VL of the third node N3 may have the same level as that of the ground voltage, and the inductor current IL may be reduced.

At the t3 time-point, when the second switching transistor Q2 is turned on, and the third switching transistor Q3 is turned off, current may flow to the inductor L via the fourth switching transistor Q4, the flying capacitor CF, and the second switching transistor Q2. The voltage VL of the third node N3 may have the same level (e.g., 1/2*VBYP (half voltage of the input voltage VBYP)) as that of the voltage VCF across both opposing ends of the flying capacitor CF, and the inductor current IL may increase.

In this way, the switching operations of the first to fourth switching transistors Q1 to Q4 may be repeated for one period T, and accordingly, the output voltage (e.g., the output voltage VSYS) obtained by stepping down the input voltage, for example, the input voltage VBYP of the first node N1 may be output via this sixth node N6.

In one example, in the converting circuit 110 implemented as the 3-level DC-DC converter, the voltage VL of the third node N3 may be determined based on the input voltage VBYP of the first node N1 and the voltage VCF across both opposing ends of the flying capacitor CF as described above. The control circuit 120 may control the voltage VCF across both opposing ends of the flying capacitor CF to have a median value of the input voltage VBYP of the first node N1, thereby reducing a ripple of the output voltage (e.g., the output voltage VSYS). In this way, balancing of the flying capacitor CF may be performed by controlling the voltage VCF across both opposing ends of the flying capacitor CF to have the median value of the input voltage VBYP of the first node N1.

FIG. 5 is a diagram for illustrating the control circuit of the charger integrated circuit according to some embodiments.

Referring to FIG. 5, the control circuit 120 may include a compensation circuit 121, an error voltage select circuit 122, and a comparison circuit 123.

The compensation circuit 121 may compensate an inductor current value VIL, SEN sensed from the current sensing circuit 113.

The compensation circuit 121 may include an amplifier 121b and passive elements, such as resistors R1 and R2 and capacitors C1 and C2. A minimum error voltage VE, SEL described later may be applied to a first input stage (+) of the amplifier 121b. One end of the resistor R1 may be connected (e.g., electrically connected) to a second input stage (−) of the amplifier 121b. The sensed inductor current value VIL, SEN may be applied to the other end of the resistor R1. The resistor R2 and the capacitors C1 and C2 may be connected (e.g., electrically connected) to and disposed between the second input stage (−) and an output stage of the amplifier 121b.

The error voltage select circuit 122 may detect errors in the output voltages based on the current IIN flowing in the first node N1, the input voltage VBYP, the output voltage VSYS, the fully-charged voltage VBAT of the battery 200, and the current IBAT flowing into the battery 200 and may select a minimum error voltage among the error voltages.

The error voltage select circuit 122 may amplify differences between the voltages or current values of reference signals IREF1, VREF1, IREF2, and VREF2 and feedback signals F1, F2, F3, F4, and F5, and may output a minimum error voltage VE, SEL among the amplified differences.

An amplifier 122a of the error voltage select circuit 122 may amplify a difference between current values of the first feedback signal F1 generated based on the current IBAT flowing into the battery 200 and the first reference current IREF1, and may output the amplified difference as a first error voltage VE, IBAT.

Furthermore, the second feedback signal F2 or the third feedback signal F3 may be generated based on the output voltage VSYS or the fully-charged voltage VBAT of the battery 200, respectively. One of the second feedback signal F2 and the third feedback signal F3 may be selected by a multiplexer MI and the selected one may be outputted.

An amplifier 122b of the error voltage select circuit 122 may amplify a difference between the voltage values of the second feedback signal F2 or the third feedback signal F3 and the first reference voltage VREF1 and may output the amplified difference as a second error voltage VE, VBAT.

Furthermore, an amplifier 122c of the error voltage select circuit 122 may amplify a difference between the current values of the fourth feedback signal F4 generated based on the current IIN of the first node (e.g., the first node N1) and the second reference current IREF2, and may output the amplified difference as a third error voltage VE, IIN.

Furthermore, an amplifier 122d of the error voltage select circuit 122 may amplify a difference between the voltage values of the fifth feedback signal F5 generated based on the input voltage VBYP and the second reference voltage VREF2 and may output the amplified difference as a fourth error voltage VE, VBYP.

Although not specifically shown, the error voltage select circuit 122 may further include passive elements such as resistors and capacitors in addition to the amplifiers 122a to 122d. Depending on an impedance ratio of the passive elements, the differences between the voltages of the reference signals IREF1, VREF1, IREF2, and VREF2 and the feedback signals F1, F2, F3, F4, and F5 may be amplified, and the amplified differences may be outputted as the error voltages VE, IBAT, VE, VBAT, VE, IIN, and VE, VBYP, respectively.

A minimum error selector MES of the error voltage select circuit 122 may select a minimum error voltage VE, SEL among the error voltages VE, IBAT, VE, VBAT, VE, IIN, and VE, VBYP. The minimum error voltage VE, SEL may be one having the smallest value among the error voltages VE, IBAT, VE, VBAT, VE, IIN, and VE, VBYP.

The compensation circuit 121 may compensate the (sensed) inductor current value VIL, SEN so as to have the same value as the minimum error voltage VE, SEL. Accordingly, a final error voltage VE, ACM may be provided to the first input stage of the comparison circuit 123, that is, the first input stage (+) of the amplifier 123a. In some embodiments, the final error voltage VE, ACM may be referred to as a control voltage. In some embodiments, the control voltage VE, ACM may be a voltage generated in an inductor average current control scheme (average current mode).

The comparison circuit 123 may generate a first PWM (Pulse Width Modulation) signal PWM1 and a second PWM signal PWM2 based on signals provided from the converting circuit (e.g., 110 in FIG. 1). The comparison circuit 123 may generate the first PWM signal PWM1 and the second PWM signal PWM2 based on a sensed input voltage VBYP, SEN, a sensed voltage VCF, SEN across both opposing ends of the flying capacitor CF, and a sensing current (e.g., the inductor current (IL in FIG. 2)).

The comparison circuit 123 may include a first comparator COM1, a second comparator COM2, a plurality of amplifiers 123a, 123b, and 123c, and resistors R3 and R4.

The first PWM signal PWM1 may be generated based on a first triangular-wave signal VTRI, POS and a first comparison voltage VC, POS. The second PWM signal PWM2 may be generated based on a second triangular-wave signal VTRI, NEG and a second comparison voltage VC, NEG. The first triangular-wave signal VTRI, POS and the second triangular-wave signal VTRI, NEG may have the same period Ts and opposite phases to each other.

The comparison circuit 123 may balance the sensed voltage VCF, SEN across both opposing ends of the flying capacitor CF using the sensed input voltage VBYP, SEN as a reference voltage.

For example, when the sensed voltage VCF, SEN across both opposing ends of the sensing flying capacitor CF is equal to 1/2 (half voltage) of the sensed input voltage VBYP, SEN, a flying capacitor balancing current ICF, BAL may not flow.

In another example, when the sensed voltage VCF, SEN across both opposing ends of the flying capacitor CF is smaller than 1/2 (half voltage) of the sensed input voltage VBYP, SEN, the flying capacitor balancing current ICF, BAL may flow in a positive direction under the operation of the comparison circuit 123. The first comparison voltage VC, POS may be provided to a second input stage of the comparison circuit 123, that may be, for example, a second input stage (−) of the amplifier 123a.

In this case, under the operation of the comparison circuit 123, a magnitude of the first comparison voltage VC, POS may be controlled to be larger than that of the control voltage VE, ACM, while a magnitude of the second comparison voltage VC, NEG may be controlled to be smaller than that of the control voltage VE, ACM.

Accordingly, a duration for which the first switching transistor Q1 and the third switching transistor Q3 are turned on may be controlled to be larger (longer) than a duration for which the second switching transistor Q2 and the fourth switching transistor Q4 are turned on. Accordingly, the voltage VCF (level) across both opposing ends of the flying capacitor CF may increase.

In another example, when the sensed voltage VCF, SEN across both opposing ends of the flying capacitor CF is greater than 1/2 (half voltage) of the sensed input voltage VBYP, SEN, the flying capacitor balancing current ICF, BAL may flow in a negative direction.

In this case, under the operation of the comparison circuit 123, a magnitude of the first comparison voltage VC, POS may be controlled to be smaller than a magnitude of the control voltage VE, ACM, while a magnitude of the second comparison voltage VC, NEG may be controlled to be larger than the magnitude of the control voltage VE, ACM.

Accordingly, a duration for which the second switching transistor Q2 and the fourth switching transistor Q4 are turned on may be controlled to be larger (longer) than a duration for which the first switching transistor Q1 and the third switching transistor Q3 are turned on. Accordingly, the voltage VCF (level) across both opposing ends of the flying capacitor CF may decrease.

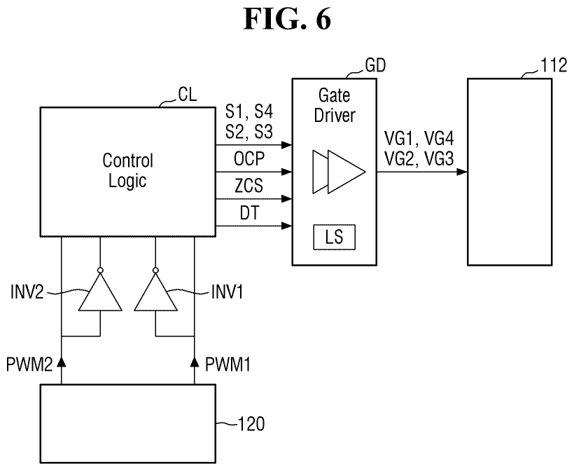

FIG. 6 is a diagram for illustrating a control logic and a gate driver of the charger integrated circuit according to some embodiments.

A control logic CL may generate first and fourth switching control signals (e.g., S1 and S4 in FIG. 6) based on the first PWM signal PWM1, and may generate second and third switching control signals (e.g., S2 and S3 in FIG. 6) based on the second PWM signal PWM2.

The first switching control signal S1 may be a signal output from the first PWM signal PWM1 through the control logic CL, and the fourth switching control signal S4 may be a signal output from the first PWM signal PWM1 through a first inverter INV1 and the control logic CL. The second switching control signal S2 may be a signal output from the second PWM signal PWM2 through the control logic CL, and the third switching control signal S3 may be a signal output from the second PWM signal PWM2 through a second inverter INV2 and the control logic CL.

The gate driver GD may change a voltage level of the first and fourth switching control signals (e.g., S1, S4 in FIG. 6) and may generate the first and fourth switching voltages VG1, VG4 respectively.

In addition, the gate driver GD may change a voltage level of the second and third switching control signals (e.g., S2, S3 in FIG. 6) and may generate the second and third switching voltages VG2, VG3 respectively.

Each of the first to fourth switching control signals S1, S2, S3, and S4 may be transmitted to a gate of each of the first to fourth switching transistors (Q1 to Q4 in FIG. 2) using a level shifter LS and the gate driver GD.

For example, the control logic CL may generate an overcurrent control signal OCP, a zero current control signal ZCS, and/or a dead-time control signal DT for each of the first to fourth switching transistors (e.g., Q1 to Q4 in FIG. 2).

For example, when the inductor current IL increases to a predetermined value, the gate driver GD may prevent the first, second, third, and fourth switching voltages VG1, VG2, VG3, and VG4 from being generated under the overcurrent control signal OCP. When the inductor current IL decreases to a predetermined value, for example, ‘0’, a zero current may be sensed under the zero current control signal ZCS, such that the gate driver GD may prevent current from flowing in a reverse direction in the power switching circuit 112. The to fourth switching voltages VG1, VG2, VG3, and VG4 may be controlled not to overlap each other under the dead-time control signal DT.

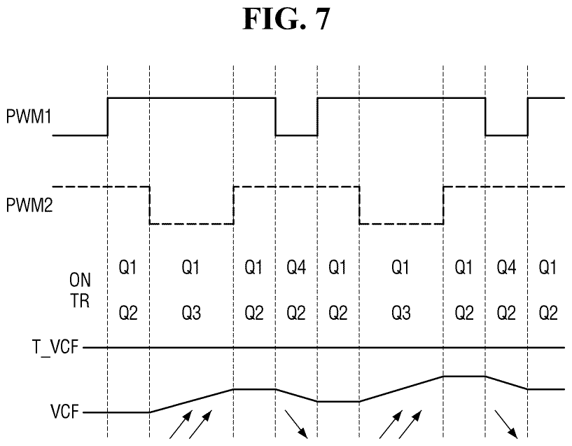

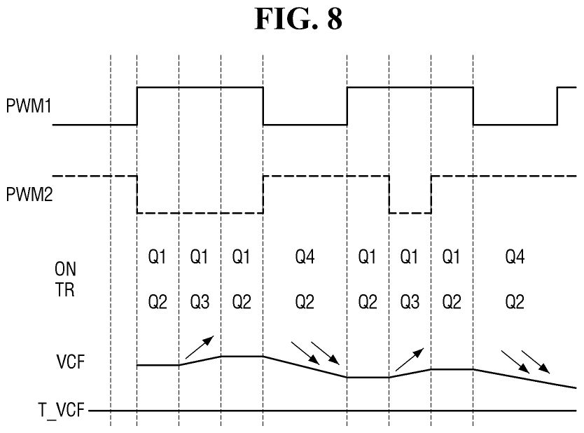

FIG. 7 and FIG. 8 are timing diagrams of signals of the converting circuit and the control circuit according to some embodiments.

Referring to FIG. 7, current flows through the flying capacitor CF for a duration for which the first switching transistor Q1 and the third switching transistor Q3 are turned on. As the current flows from the second node N2 to the fourth node N4, the flying capacitor CF may be charged such that the voltage level VCF across both opposing ends of the flying capacitor CF increases.

When the voltage VCF across both opposing ends of the flying capacitor CF is lower than a target voltage (T_VCF, i.e., 1/2*VBYP), the control circuit 120 may control a duration for which the first switching transistor Q1 and the third switching transistor Q3 are turned on to be larger (longer) than a duration for which the second switching transistor Q2 and the fourth switching transistor Q4 are turned on. Accordingly, the voltage VCF across both opposing ends of the flying capacitor CF increases so as to be closer to the target voltage (T_VCF, that is, 1/2*VBYP).

Referring to FIG. 8, for a duration for which the second switching transistor Q2 and the fourth switching transistor Q4 are turned on, the current flows from the fourth node N4 to the second node N2. As the flying capacitor CF is discharged, the voltage level VCF across both opposing ends of the flying capacitor CF decreases.

When the voltage VCF across both opposing ends of the flying capacitor CF is higher than the target voltage (T_VCF, i.e., 1/2*VBYP (half voltage of the input voltage VBYP)), the control circuit 120 may control the duration for which the first switching transistor Q1 and the third switching transistor Q3 are turned on to be smaller (shorter) than the duration for which the second switching transistor Q2 and the fourth switching transistor Q4 are turned on. Accordingly, the voltage VCF across both opposing ends of the flying capacitor CF decreases so as to be closer to the target voltage (T_VCF, i.e., 1/2*VBYP (half voltage of the input voltage VBYP)).

According to some embodiments, the first and second switching signals SS1 and SS2 that control the switching operations of the first to fourth switching transistors Q1 to Q4 may be generated using a final error voltage VE, ACM obtained by correcting the sensed inductor current value VIL, SEN. Accordingly, in balancing the voltage VCF across both opposing ends of the flying capacitor CF into the target voltage (T_VCF, i.e., 1/2*VBYP (half voltage of the input voltage VBYP)) and providing the voltage and/or the current to the battery 200, the charger integrated circuit may be controlled at a more stable and faster response manner.

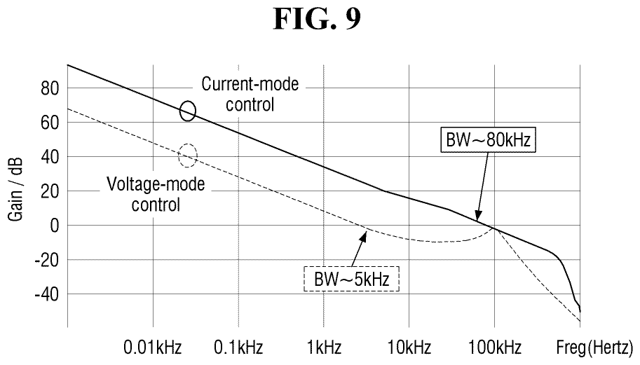

FIGS. 9 to 12 are diagrams for illustrating effects of using the charger integrated circuit according to some embodiments.

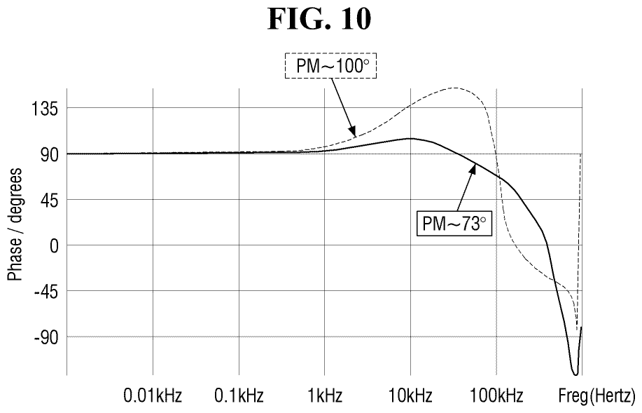

FIG. 9 and FIG. 10 show comparison between control characteristics of an average current control scheme (average current mode control) and a voltage control scheme (voltage mode control) under the same operating condition.

Referring to FIG. 9, in the voltage control scheme (voltage mode control), a resonant pole frequency split phenomenon appears at about 100 kHz, and thus, a bandwidth (BW) of about 5 kHz may be obtained. However, in the average current control scheme (average current mode control), the resonance pole frequency split phenomenon may be reduced compared to the voltage control scheme (voltage mode control), and thus, a bandwidth (BW) of about 80 kHz may be obtained.

Furthermore, referring to FIG. 10, it may be identified that in the voltage control scheme (voltage mode control), a phase margin (PM) is about 100°, while in the average current control scheme (average current mode control), the phase margin (PM) is about 73°. That is, in the average current control scheme (average current mode control), the charger integrated circuit (e.g., 100 in FIG. 1) may be controlled in a more stable and faster response manner.

In another example, in a peak current control scheme (peak current mode control) in which the current sensing values of the first and the second switching transistors Q1 and Q2 or the current sensing values of the third and the fourth switching transistors Q3 and Q4 are directly compared with the error voltage, a mismatch may occur in the current sensing values of the first and second switching transistors Q1 and Q2 or the current sensing values of the third and the fourth switching transistors Q3 and Q4. This does not guarantee the same on-time of the first and second switching transistors Q1 and Q2 or the third and fourth switching transistors Q3 and Q4, such that the voltage (e.g., the voltage VCF) across both opposing ends of the flying capacitor (e.g., the flying capacitor CF) is not controlled to 0.5 times (half voltage) of the input voltage (e.g., the input voltage VBYP), and distortion in the current and voltage waveforms may occur, thereby not guaranteeing stable operation.

However, in the average current control scheme (average current mode control) according to some embodiments, the mismatch regarding the current sensing values of the switching transistors (e.g., the first to fourth switching transistors Q1 to Q4) may be minimized using the average value of the inductor current (e.g., the inductor current IL).

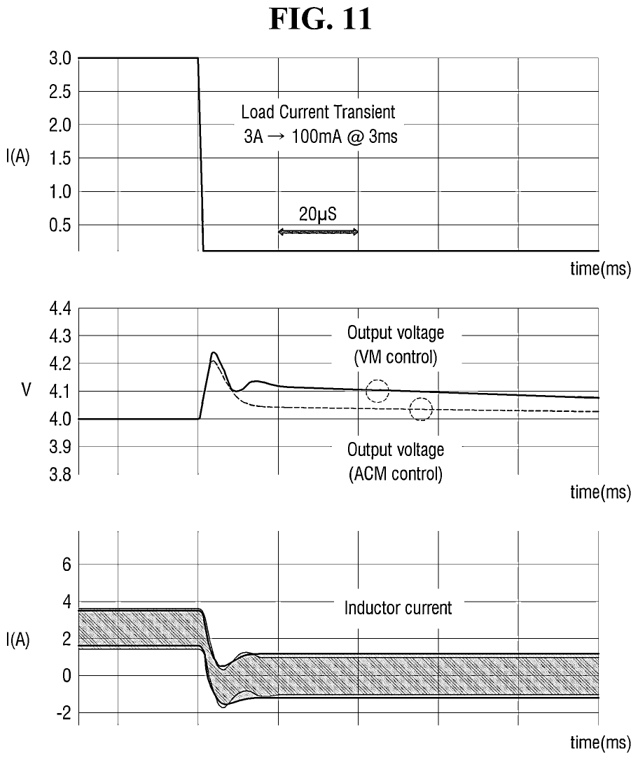

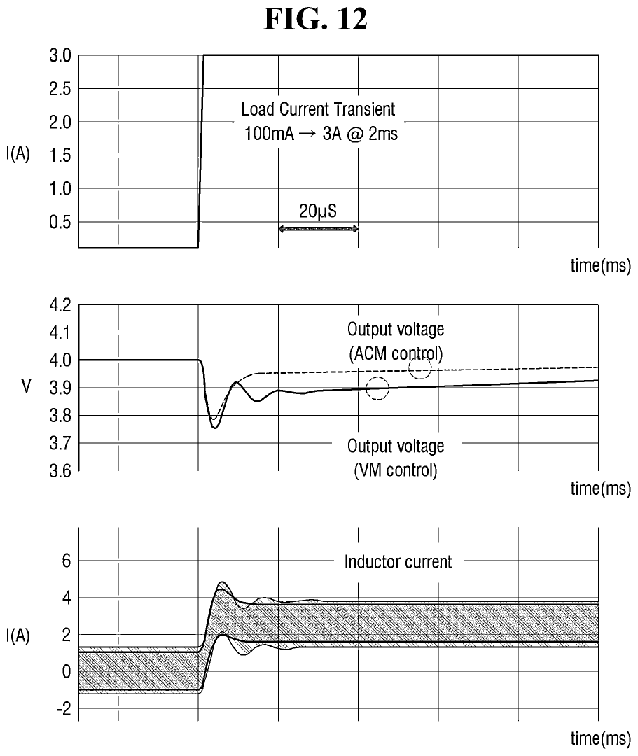

FIG. 11 and FIG. 12 are diagrams comparation between load transient response characteristics of the voltage control scheme (voltage mode (VM) control) and the average current control scheme (average current mode (ACM) control).

Referring to FIG. 11 and FIG. 12, it may be identified that a transient voltage is smaller and is shorter in the average current control scheme (average current mode (ACM) control) compared to the voltage control scheme (voltage mode (VM) control).

That is, in the average current control scheme (average current mode (ACM) control), the frequency characteristics of a control loop may be more stable, and fluctuations in the output voltage VBAT or VSYS may be suppressed to a minimum level.

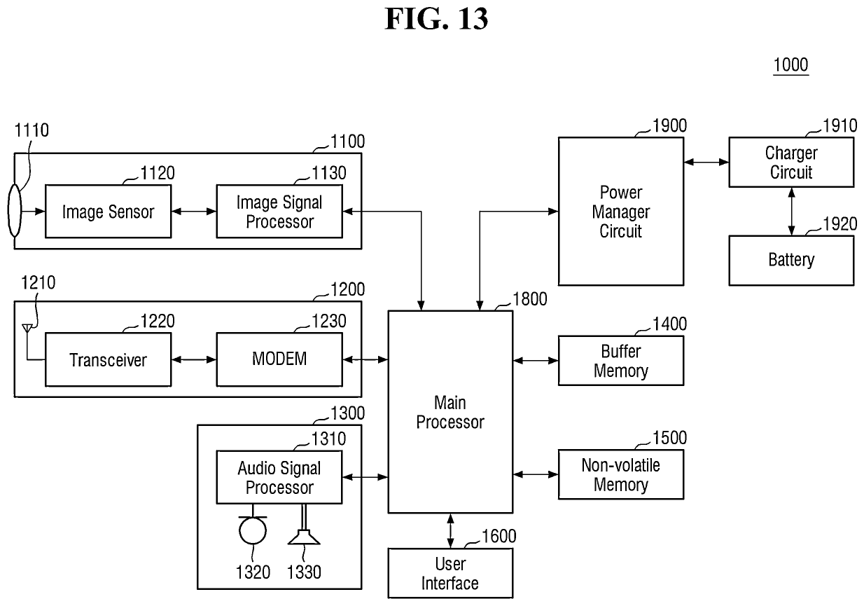

FIG. 13 is a diagram schematically showing an electronic device including a charger integrated circuit according to some embodiments.

An electronic device 1000 may include various electronic circuits. For example, the electronic circuits of the electronic device 1000 may include an image processing block 1100, a communication block 1200, an audio processing block 1300, a buffer memory 1400, a non-volatile memory 1500, and a user interface 1600, a main processor 1800, a power management circuit 1900, and a charger integrated circuit 1910.

The electronic device 1000 may be connected (e.g., electrically connected) to a battery 1920, and the battery 1920 may supply power used to operate the electronic device 1000 thereto. However, the present disclosure is not limited thereto, and the power supplied to the electronic device 1000 may be provided from an internal/external power source other than the battery 1920.

The image processing block 1100 may receive light through a lens 1110. An image sensor 1120 and an image signal processor 1130 included in the image processing block 1100 may generate image information related to an external object based on the received light.

The communication block 1200 may exchange signals with an external device/system via an antenna 1210. A transceiver 1220 and a modulator/demodulator (MODEM) 1230 of the communication block 1200 may process the signals exchanged with the external devices/system according to one or more of various wired/wireless communication protocols.

The audio processing block 1300 may process sound information using an audio signal processor 1310. The audio processing block 1300 may receive an audio input through a microphone 1320 and output an audio through a speaker 1330.

The buffer memory 1400 may store therein data used in the operation of the electronic device 1000. In an example, the buffer memory 1400 may temporarily store therein data processed or to be processed by the main processor 1800. For example, the buffer memory 1400 may include a volatile memory such as Static Random Access Memory (SRAM), Dynamic RAM (DRAM), Synchronous DRAM (SDRAM), and/or a non-volatile memory such as Phase-change RAM (PRAM), Magneto-resistive RAM (MRAM), ReRAM (Resistive RAM), FRAM (Ferro-electric RAM), etc.

The non-volatile memory 1500 may store therein data regardless of whether power is supplied thereto. For example, the non-volatile memory 1500 may include a non-volatile memories such as flash memory, PRAM, MRAM, ReRAM, FRAM, etc. For example, the non-volatile memory 1500 may include a removable memory such as a Secure Digital (SD) card or Solid State Drive (SSD), and/or an embedded memory such as an Embedded Multimedia Card (eMMC).

The user interface 1600 may mediate communication between a user and the electronic device 1000. For example, the user interface 1600 may include an input interface for receiving an input from the user and an output interface for providing information to the user.

The main processor 1800 may control overall operations of the components of the electronic device 1000. The main processor 1800 may process various computations to operate the electronic device 1000. For example, the main processor 1800 may be implemented as a general-purpose processor, a special-purpose processor, an application processor, a microprocessor, etc., and may include one or more processor cores.

The power management circuit 1900 may supply power to the components of the electronic device 1000, and may manage the power. For example, the power management circuit 1900 may output a system voltage based on the power provided from the charger integrated circuit 1910 and/or the battery 1920. The power management circuit 1900 may adjust a frequency of each component and a voltage level of the provided system voltage based on a temperature and an operation mode of each of the components.

The charger integrated circuit 1910 may charge the battery 1920 based on power provided from an external power source, or may provide power to the power management circuit 1900. The charger integrated circuit 1910 may provide power to an external device via a wired or wireless power interface based on the power provided from the battery 1920.

The charger integrated circuit 100 as described with reference to FIGS. 1 to 12 may be applied to as the charger integrated circuit 1910 of the electronic device 1000. The charger integrated circuit 100 may be implemented as a 3-level DC-DC converter. The charger integrated circuit 100 may generate the first and second switching signals SS1 and SS2 that control the switching operations of the first to fourth switching transistors Q1 to Q4 using the control voltage VE, ACM obtained by corrects the sensed inductor current values VIL, SEN. Accordingly, in balancing the voltage VCF across both opposing ends of the flying capacitor CF so as to have the target level (T_VCF, i.e., 1/2*VBYP (half voltage of the input voltage VBYP)) and providing the voltage and/or current to the battery 200, the charger integrated circuit 100 may be controlled in a more stable and fast response manner.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above is not restrictive but illustrative in all respects.

What is claimed is:

1. An electronic device comprising:
a battery; and
a charger integrated circuit that is configured to perform a buck converting operation based on an input voltage that is applied to a first node thereof to generate an output voltage output to a second node thereof,
wherein the charger integrated circuit includes:
a power switching circuit that is configured to receive the input voltage, wherein the power switching circuit includes first, second, third, and fourth switching transistors and a flying capacitor that is electrically connected to a first end of the second switching transistor and a first end of the third switching transistor;
a current sensing circuit that includes an inductor that is electrically connected to and disposed between the second node and a third node, wherein the third node is electrically connected to a second end of the second switching transistor and a second end of the third switching transistor; and
a control circuit that includes:
a compensation circuit that is configured to compensate an inductor current value that is sensed from the current sensing circuit;
an error voltage select circuit that is configured to generate a minimum error voltage based on feedback signals; and
a comparison circuit that is configured to control a voltage of the flying capacitor,
wherein the control circuit is configured to generate a control voltage by modifying the inductor current value based on the minimum error voltage and provide the control voltage to a first input stage of the comparison circuit.

2. The electronic device of claim 1, wherein the compensation circuit is configured to compensate the inductor current value based on the minimum error voltage to have a same value as the minimum error voltage.

3. The electronic device of claim 1, wherein the error voltage select circuit is configured to amplify differences between voltage values of reference signals and voltage values of the feedback signals and to determine the minimum error voltage from the amplified differences, and
wherein the compensation circuit is configured to compensate the inductor current based on the minimum error voltage.

4. The electronic device of claim 1, wherein the comparison circuit is configured to:
generate a first pulse width modulation (PWM) signal based on a first triangular-wave signal and a first comparison voltage,
generate a second PWM signal based on a second triangular-wave signal and a second comparison voltage,
control the first comparison voltage compared to the control voltage, and
control the second comparison voltage compared to the control voltage.

5. The electronic device of claim 4, wherein the charger integrated circuit further includes a control logic that is configured to generate a first switching control signal and a fourth switching control signal based on the first PWM signal and generate a second control switching signal and a third switching control signal based on the second PWM signal.

6. The electronic device of claim 5, wherein the charger integrated circuit further includes a gate driver that is configured to:
generate a first switching voltage and a fourth switching voltage based on the first switching control signal and the fourth switching control signal; and
generate a second switching voltage and a third switching voltage based on the second switching control signal and the third switching control signal.

7. The electronic device of claim 6, wherein the first switching voltage and the fourth switching voltage are complementary with each other, and the second switching voltage and the third switching voltage are complementary with each other.

8. The electronic device of claim 1, wherein the voltage of the flying capacitor is controlled to be equal to half voltage of the input voltage.

9. The electronic device of claim 4, wherein the first comparison voltage is provided to a second input stage of the comparison circuit, and
wherein the comparison circuit is configured to control a magnitude of the first comparison voltage to be larger than that of the control voltage.

10. The electronic device of claim 4, wherein the comparison circuit is configured to control a magnitude of the first comparison voltage to be smaller than that of the control voltage.

11. The electronic device of claim 9, wherein the comparison circuit is configured, when the voltage of the flying capacitor is smaller than half voltage of the input voltage, to flow a flying capacitor balancing current in a positive direction and to control a first duration for which the first switching transistor and the third switching transistor are turned on to be longer than a second duration for which the second switching transistor and the fourth switching transistor are turned on, so that the voltage of the flying capacitor increases.

12. The electronic device of claim 10, wherein the comparison circuit is configured, when the voltage of the flying capacitor is greater than half voltage of the input voltage, to flow the flying capacitor balancing current in a negative direction and to control a second duration for which the second switching transistor and the fourth switching transistor are turned on to be longer than a first duration for which the first switching transistor and the third switching transistor are turned on, so that the voltage of the flying capacitor decreases.

13. A charger integrated circuit comprising:
a converting circuit that is configured to generate an output voltage that outputs to a second node thereof based on an input voltage that is applied to a first node thereof; and
a control circuit that is configured to generate a first pulse width modulation (PWM) signal and a second PWM signal for controlling the converting circuit,
wherein the converting circuit includes:
a power switching circuit that is configured to receive the input voltage, wherein the power switching circuit includes first, second, third, and fourth switching transistors that are electrically connected in series with each other and a flying capacitor that is electrically connected to a first end of the second switching transistor and a first end of the third switching transistor; and
a current sensing circuit that includes an inductor that is electrically connected to a third node and disposed between the third node and the second node,
wherein the control circuit includes:
a compensation circuit that is configured to compensate an inductor current value that is sensed from the current sensing circuit;
an error voltage select circuit that is configured to generate a minimum error voltage based on feedback signals; and
a comparison circuit that is configured to control a voltage of the flying capacitor,
wherein the inductor current value is compensated to have a same value as the minimum error voltage.

14. The charger integrated circuit of claim 13, wherein the comparison circuit is configured to control the voltage of the flying capacitor based on the inductor current value.

15. The charger integrated circuit of claim 13, wherein the error voltage select circuit is configured to amplify differences between voltage values of reference signals and voltage values of the feedback signals and to determine the minimum error voltage from the amplified differences.

16. The charger integrated circuit of claim 13, wherein the converting circuit further includes a first input transistor that is configured to receive a first input voltage, and a second input transistor that is configured to receive a second input voltage,
wherein the input voltage is generated based on the first input voltage and/or the second input voltage.

17. The charger integrated circuit of claim 13, wherein the comparison circuit is configured to:
generate the first PWM signal based on a first triangular-wave signal and a first comparison voltage; and
generate the second PWM signal based on a second triangular-wave signal and a second comparison voltage,
wherein the charger integrated circuit further comprises:
a control logic that is configured to generate a first switching control signal and a fourth switching control signal based on the first PWM signal and to generate a second switching control signal and a third switching control signal based on the second PWM signal; and
a gate driver that is configured to:
generate a first switching voltage and a fourth switching voltage based on the first switching control signal and the fourth switching control signal; and
generate a second switching voltage and a third switching voltage based on the second switching control signal and the third switching control signal.

18. The charger integrated circuit of claim 13, wherein the voltage of the flying capacitor is controlled to have half voltage of the input voltage.

19. The charger integrated circuit of claim 13, wherein the control circuit is configured to generate a control voltage by compensating the inductor current value based on the minimum error voltage and provide the control voltage to a first input stage of the comparison circuit,
wherein the control circuit is configured to provide a first comparison voltage to a second input stage of the comparison circuit, and
wherein the comparison circuit is configured to control a first duration for which the first switching transistor and the third switching transistor are turned on and a second duration for which the second switching transistor and the fourth switching transistor are turned on to control the voltage of the flying capacitor.

20. A charger integrated circuit comprising:
a converting circuit that is configured to generate an output voltage that outputs to a second node thereof based on an input voltage that is applied to a first node thereof; and
a control circuit that is configured to generate first, second, third, and fourth switching voltages based on a signal that is provided from the converting circuit,
wherein the converting circuit includes:
an input/output select circuit that includes a first input transistor that is configured to receive a first input voltage and a second input transistor that is configured to receive a second input voltage;
a power switching circuit that is configured to receive the input voltage based on the first input voltage and/or the second input voltage and includes first, second, third, and fourth switching transistors that are electrically connected in series with each other and a flying capacitor that is electrically connected to a first end of the second switching transistor and a first end of the third switching transistor, and
a current sensing circuit that includes an inductor that is electrically connected to a third node and disposed between the third node and the second node,
wherein a control voltage is generated based on an inductor current value sensed from the inductor of the current sensing circuit,
wherein the control voltage is provided to an input stage of the control circuit,
wherein the control circuit is configured to:
control a magnitude of each of the control voltage and first and second comparison voltages; and
control a duration for which each of the first, second, third, and fourth switching transistors is turned on so that a voltage of the flying capacitor is balanced to have half voltage of the input voltage.
